(19) United States
(12) Patent Application Publication
(10) Pub. No.: US 2008/0204869 A1
(43) Pub. Date: Aug. 28, 2008

(54) COUNTER TOP PROJECTION SCREEN AND COUNTER STRUCTURE

(76) Inventor: Grant W. STEWART, Cincinnati, OH (US)

Correspondence Address: HASSE & NESBITT LLC, 8837 CHAPEL SQUARE DRIVE, SUITE C, CINCINNATI, OH, 45249, US

(21) Appl. No.: 12/038,252

(22) Filed: Feb. 27, 2008

Related U.S. Application Data
(60) Provisional application No. 60/891,784, filed on Feb. 27, 2007.

(51) Int. Cl. G03B 21/56

(52) U.S. Cl. 359/460

(57) ABSTRACT

A bar or counter structure is provided that includes a rear projection screen disposed in an opening defined in the upper surface of the structure and a projection system for projecting images onto the projection screen from beneath the screen.

### CROSS-REFERENCE TO RELATED APPLICATIONS

This application claims the benefit of co-pending U.S. Provisional Application No. 60/891,784, filed Feb. 27, 2007.

### TECHNICAL FIELD

This invention relates generally to bar or service counter or like structures, and more particularly, the invention relates to a bar counter top or similar service counter structure incorporating a rear projection screen in the top surface of the structure and a projection system for projecting images from within the structure for display on the projection screen.

### BACKGROUND OF THE INVENTION

Service counter structures such as bars or tables found in eating and drinking establishments are conventionally structured to define service or work area surfaces for serving food and drink and accordingly are not constructed in a manner suitable for displaying visual material to a patron or other user seated at the counter. In existing restaurant, pub and bar establishments, entertainment or informational visual displays where provided are customarily wall mounted television sets or video projectors displaying images on wall mounted projection screens. Accordingly, a patron of the establishment may find difficulty in viewing the images from his particular vantage point in the establishment. Similarly, conventional desk or table structures do not include projection screens in the top work surfaces thereof for viewing instructional or lecture materials. There exists a need therefore for a bar or other service counter structure having means built in for displaying visual content to a person seated at the counter for entertainment or informational purposes.

### SUMMARY OF THE INVENTION

The invention provides a bar top or counter top structure including a rear projection screen disposed within a opening defined in the upper surface of the structure and a projection system for projecting images onto the projection screen from beneath the screen.

The invention therefore relates to a counter top structure including a top surface on the structure defining a work or service area of the structure; an opening defined in the top surface; a rear projection screen disposed within said opening, said rear projection screen having a top surface and a bottom surface and configured for displaying at the top surface visual content projected onto the bottom surface. In one embodiment, the counter top structure further comprises projector means for projecting visual content onto the rear projection screen at the bottom surface thereof.

The invention also relates to improvements in a counter top structure wherein a top surface of the structure includes an opening and a rear projection screen disposed therein having a top surface and a bottom surface and configured for displaying at the top surface visual content projected onto the bottom surface, and further comprising means for projecting visual content onto the rear projection screen at the bottom surface thereof.

The invention also relates to a counter structure having in the top surface thereof a projection screen including at least one glass layer or two glass layers with a polymer layer between the glass layers.

The invention contemplates the use of projector means either within the structure itself or remote of the structure for projecting visual content onto the projection screen and may include any of the projector means known in the art, including a television projector, motion picture projector, slide projector, video projector and computer generated images display system.

A principal aspect of the invention resides in a bar or counter structure that includes in the top surface a rear projection screen for displaying images to the patron seated at the bar or counter.

In another aspect of the invention, the bar top or counter top structure is both the projection display screen and a service or work area.

An advantage of the invention resides in the provision of a bar top or counter top structure having a waterproof top surface comprising a projection screen that serves both as a service area for receiving food or drink and as a viewing area for viewing visual content displayed on the screen.

In another aspect of the invention, the projection screen can be co-planer with the top surface of the counter or recessed into the counter top.

Another advantage of the bar top or counter top structure of the invention resides in the ability of a patron seated at the bar or counter to view directly in front of him visual content conventionally presented by wall mounted television sets without the need to turn or look up or away from his seat at the bar or counter.

Another aspect of the invention resides in the applicability of the invention to desk top or table top structures wherein a projection screen is disposed in the top surface of the structure, whereby images from a projection source may be viewed as projected from beneath the projection screen.

A further aspect of the invention resides in its applicability to table tops, coffee tables, desk surfaces, conference tables, checkout counters, customer service counters, or other applications.

Other aspects, advantages and objects of the invention will become apparent as a detailed description of representative embodiments of the invention proceeds.

### BRIEF DESCRIPTION OF THE DRAWINGS

The invention will be more clearly understood from the following detailed description of representative embodiments thereof read in conjunction with the accompanying drawings that form a part of this disclosure.

FIG. 1 is a perspective view in partial cutaway of a bar structure according to the invention containing a rear projection screen and projection system.

FIG. 2 is a sectional view of the FIG. 1 bar structure as viewed along lines 2-2 illustrating a structure for the projection screen of the invention.

### DETAILED DESCRIPTION OF THE INVENTION

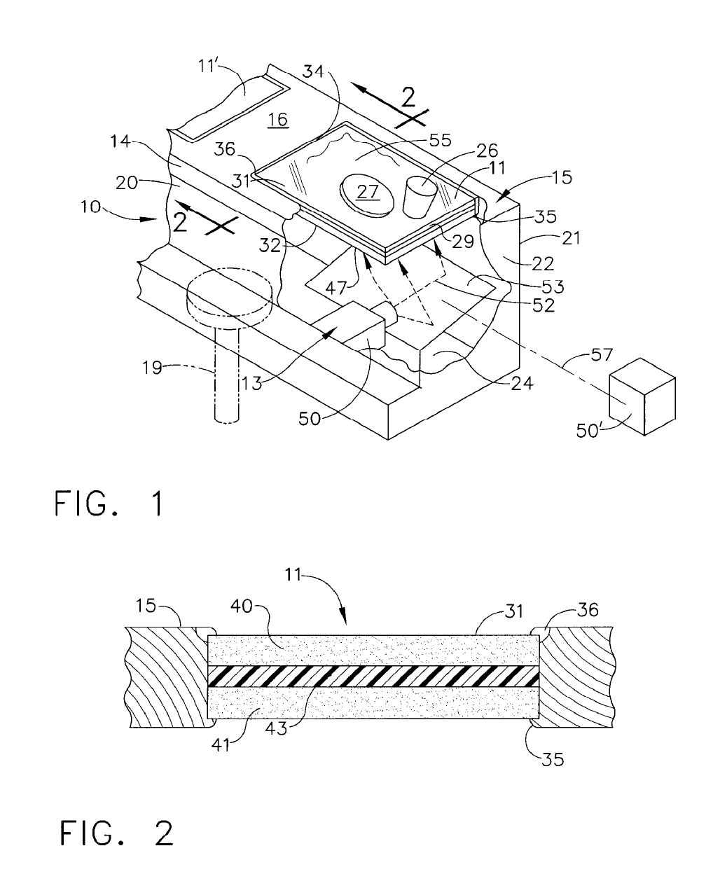

Referring now to the drawings, FIG. 1 is a perspective view in partial cutaway of a bar top or service counter top structure 10 containing a rear projection screen 11 structure and a projection system 13, according to the invention. FIG. 2 is a view in section of a portion of the FIG. 1 structure 10 as taken along lines 2-2 illustrating a projection screen structure useful in the invention. It should be noted at the outset that the bar top or service counter top structure 10 depicted in the drawings is described herein as a bar structure having an upper surface defining a service area into which a rear projection screen according to the invention can be incorporated, and is representative only of the structures having work or service surface areas into which the invention can be incorporated. The invention can also be used in conjunction with conventional table tops, coffee table surfaces, desk top surfaces, conference table surfaces, customer service counters, display counters, or like structures, all of which structures, along with bars and service counters customarily found in restaurants, pubs and bars, are for the purpose of describing the invention herein considered within these teachings to define generally counter structures with work or service areas into which the invention may be incorporated.

With reference now specifically to the representative structure 10 depicted in FIG. 1, structure 10 can comprise in substantially conventional fashion a top wall member 14 supporting top surface 15 that defines a work area (for such as a desk), or a service area 16 for a bar structure useful for providing service to a patron who can be seated at the bar such as on stool 19. Structure 10 can be further defined by front, back and end walls 20, 21 and 22 defining an interior volume 24 of structure 10 beneath top surface 15. It is noted that structure 10 can comprise substantially any of the materials of construction conventionally used in such structures and are included in the scope of these teachings, including woods, laminates, ceramics, metals, or others as would be selected by one skilled in the applicable art guided by these teachings, the same not considered limiting of the invention or of the appended claims.

In accordance with a principal feature of the invention, a rear projection screen 11 is incorporated into the generally horizontal top surface 15 of structure 10 in order to display images in the form of a television display, movie, computer generated display, slide show or other visual display for presentation to a patron or other person seated at structure 10. Screen 11 may be disposed within top surface 15 in manner such that the top surface of screen 11 is substantially co-planar with top surface 15, or, in some applications, it may be desirable to recess screen 11 into top wall member 14 so that the top surface of screen 11 lies below surface 15, or to mount screen 11 in a raised condition somewhat above surface 15. In some non-limiting examples of the visual displays contemplated herein, for structure 10 in the form of a desk, table, or like structure, the visual display presentation may be such as lecture or other instructional display or presentation. For a structure 10 in the form of a bar or other service counter, the visual display may more appropriately be in the form of television displays (including sports, news or other broadcasts) or movie presentations or other forms for the convenience and entertainment of a patron seated at the bar.

The structure of screen 11 may comprise substantially any composition or number of layers or combination materials customarily used in rear projection screen structures including glass, polymers, plastics or others as would occur to the skilled artisan guided by these teachings, requiring only that the overall structure of screen 11 be strong enough to support items such as drink containers 26, plates of food 27 and the like (in the example of a bar or service counter structure) in providing service to a patron, or to support instructional materials (books or the like in the example of a desk or like structure) that may be placed on a top surface 15 having screen 11 disposed therein in the intended use of the structure. Representative structures for screen 11 include one or more layers 29 of plate glass of suitable thickness to provide the required strength (such as 0.125 inch thick or more) for supporting the weight of items that may be anticipated for placement on the screen. Screen 11 may be held in any suitable fashion within an opening 34 in top surface 15, such as by a flanged arrangement 35 on the inside edge of opening 34, and sealed around the periphery of screen 11 using conventional sealing materials, gaskets or the like as suggested at 36 in order to provide a surface 15 that is both sealed against water or other liquid penetration and presents a surface for the top of structure 10 that can be conveniently cleaned. One or more of the upper or lower surfaces 31 or 32 of the constituent layers 29 can have a smoked or frosted (etched) surface in order to provide a projection surface required to display images in accordance with the invention, all as hereinafter more fully described. More than one such screens 11 may be incorporated side-to-side into structure 10 as suggested at 11′ in order to accommodate additional patrons or other users (not shown in the drawings) seated side-to-side.

FIG. 2 is a sectional view taken along lines 2-2 of top surface 15 of the FIG. 1 structure, illustrating a projection screen 11 useful in the invention which may comprise a layered structure of at least two glass plates 40 and 41 (about 0.125 inch thick or thicker for enhanced strength) with a polymer layer 43 (such as translucent polyvinyl butyral about 0.015 inch thick) disposed between the glass plates. One such useful non-limiting example structure for screen 11 includes the projection screen material STARGLAS (Stewart Filmscreen Corporation) suitable for use simultaneously as a rear projection screen for the desired visual display and as a service area (for a bar), a work area (for desk or table), or display area (for such as a display case) Upper surface 31 of plate 40 may have surface roughness as by frosting or etching and conventional antireflection coatings to prevent unwanted reflections. Glass composition and additives may be selected by one skilled in the applicable art in practicing the invention as taught herein. Polymer sheets useful in the structure of screen 11 may otherwise include any of those described in U.S. Pat. No. 7,253,953 to Browning, and in U.S. Pat. No. 6,825,255 to Yuan et al., the entire teachings of both being incorporated herein by reference, such as polyvinyl butyral, polyurethane, polyvinyl chloride, or poly(ethylene vinyl acetate), or combinations thereof.

With reference again to FIG. 1, and in accordance with another feature of the invention, a source of a visual display in the form of projector means 13 may be disposed within structure 10 in order to project images onto projection screen 11 from beneath top surface 15, for display to a patron or other user of structure 10. In one embodiment as suggested in FIG. 1, a projection system 50 can be disposed within structure 10 for providing imagery projection 52 by suitable optical means, such as using one or more reflective means 53, onto the underside 47 of projection screen 11 so that the patron can view the graphical content of images 55 displayed at upper surface 31 that are defined by the imagery projection 52.

It is noted that an additional protective layer (not shown) of clear plastic, glass or other clear transparent material may be applied over the screen structure in order to preclude scratching or other surface damage to the exposed upper surface 31 of the screen 11. This may be particularly desirable for bar top or counter top structures according to the invention wherein screen 11 is recessed into top wall member 14 so that upper surface 31 of screen 11 lies at a level below the level of top surface 15.

The projection system 50 that provides the projected images within the intended scope of the invention and of the appended claims may comprise any conventional projection means including television projector, motion picture or slide projector, or video projector, or a computer generated images display system, or the like, disposed within structure 10. Alternatively, the projection system 50′ may be disposed remote of structure 10 with optical means 57 (such as by use of conventional fiber optics devices illustrated by the broken line in FIG. 1) to conduct the imagery from such remotely disposed projection source 50′ for display on screen 11 as described above.

The invention therefore provides a novel structure for a bartop, service or display counter top, desk top or the like having in the top surface thereof a rear projection screen, and a projection system for displaying images on the screen from beneath the screen. It is understood that modifications to the invention may be made as might occur to one with skill in the field of the invention within the scope of the appended claims. All embodiments contemplated hereunder that achieve the benefits of the invention have therefore not been shown in complete detail. Other embodiments may be developed without departing from the spirit of the invention or from the scope of the appended claims.

What is claimed is:

1. A counter structure, comprising:
(a) a top surface on said structure, said top surface defining a work or service area of said structure;
(b) an opening defined in said top surface; and
(c) a rear projection screen disposed within said opening, said rear projection screen having a top surface and a bottom surface, and configured for displaying at said top surface visual content projected onto said bottom surface.

2. The counter structure of claim 1 further comprising projector means for projecting visual content onto said rear projection screen at said bottom surface thereof.

3. The counter structure of claim 2 wherein said projector means is disposed remote of said structure, and comprising optical means for transmitting said visual content from said projector means onto said bottom surface of said screen.

4. The counter structure of claim 1 wherein said top surface of said rear projection screen is substantially co-planar with said top surface of said structure.

5. The counter structure of claim 1 wherein said rear projection screen comprises at least one layer of glass.

6. The counter structure of claim 1 where said rear projection screen comprises at least two layers of glass with a polymer sheet disposed between two said glass layers.

7. The counter structure of claim 6 wherein said polymer sheet comprises a polymer selected from the group consisting polyvinyl butyral, polyurethane, polyvinyl chloride, and poly (ethylene vinyl acetate).

8. The counter structure of claim 2 wherein said projector means is selected from the group consisting of a television projector, motion picture projector, slide projector, video projector, and computer generated images display system.

9. In a counter structure having a top surface defining at least one of a work or service area of said structure, an improvement, comprising;
(a) an opening defined in said top surface;
(b) a rear projection screen disposed within said opening, said rear projection screen having a top surface and a bottom surface and configured for displaying at said top surface visual content projected onto said bottom surface; and
(c) projector means for projecting visual content onto said rear projection screen at said bottom surface thereof.

10. The counter structure of claim 9 wherein said projector means is disposed remote of said structure, and comprising optical means for transmitting said visual content from said projector means onto said bottom surface of said screen.

11. The improvement of claim 9 wherein said top surface of said rear projection screen is substantially co-planar with said top surface of said structure.

12. The improvement of claim 9 wherein said rear projection screen comprises at least one layer of glass.

13. The improvement of claim 9 where said rear projection screen comprises at least two layers of glass with a polymer sheet disposed between two said glass layers.

14. The improvement of claim 13 wherein said polymer sheet comprises a polymer selected from the group consisting polyvinyl butyral, polyurethane, polyvinyl chloride, and poly(ethylene vinyl acetate).

15. The improvement of claim 9 wherein said projector means is selected from the group consisting of a television projector, motion picture projector, slide projector, video projector, and computer generated images display system.

16. In a counter structure having a top surface defining at least one of a work or service area of said structure, an improvement, wherein an opening is defined in said top surface of the counter structure, and a rear projection screen is disposed within said opening, said rear projection screen having a top surface and a bottom surface and configured for displaying at said top surface visual content projected onto said bottom surface, and comprising means for projecting visual content onto said rear projection screen at said bottom surface thereof.

17. The improvement of claim 16 wherein said means for projecting visual content onto said rear projection screen is disposed remote of said structure.

18. The improvement of claim 16 wherein said rear projection screen comprises at least one layer of glass.

19. The improvement of claim 18 where said rear projection screen comprises at least two layers of glass with a polymer sheet disposed between two said glass layers.

20. The improvement of claim 16 wherein said means for projecting visual content onto said rear projection screen includes projector means selected from the group consisting of a television projector, motion picture projector, slide projector, video projector, and computer generated images display system.
